(19) United States
(12) Patent Application Publication
(10) Pub. No.: US 2014/0042706 A1
(43) Pub. Date: Feb. 13, 2014

(54) EXPANDING MATERIAL IN NONWOVEN 3-D STRUCTURE

(71) Applicants: Thomas Sam PILLARS, St. Clair Shores, MI (US); Patricia Heidtman, Farmington Hills, MI (US); Frank Hoefflin, Baden (CH); Eric R. Medaris, Grosse Pointe Woods, MI (US); John I. Hanley, IV, Sterling Heights, MI (US)

(72) Inventors: Thomas Sam PILLARS, St. Clair Shores, MI (US); Patricia Heidtman, Farmington Hills, MI (US); Frank Hoefflin, Baden (CH); Eric R. Medaris, Grosse Pointe Woods, MI (US); John I. Hanley, IV, Sterling Heights, MI (US)

(73) Assignee: SIKA TECHNOLOGY AG, Baar (CH)

(21) Appl. No.: 13/584,360

(22) Filed: Aug. 13, 2012

(51) Int. Cl. E04B 1/68; B32B 1/06; D04H 1/00; B32B 5/26; B29C 47/00; F16J 15/10

(52) U.S. Cl. 277/316; 264/103; 442/414; 442/335; 442/381; 428/36.1

(57) ABSTRACT

A continuous filament non-woven web is disclosed, wherein filaments of the web include an expandable thermoplastic material. Mattings fabricated from the continuous filament non-woven web are also disclosed. The web or matting can be used in sealing applications as it can be cut into desired dimensions and inserted into a cavity. The web or matting allows for introduction and drainage of further fluids in and from the cavity. The extendable thermoplastic material can be activated and foamed to fill a part of or the entire cavity. The sealing can prevent air, water or noise from intruding into the cavity and a space behind that cavity.

### FIELD

The present disclosure is directed at continuous filament non-woven webs wherein the filaments of the webs include an expandable thermoplastic material.

### BACKGROUND

Dry, pre-formed heat-reactive expandable sealers have unique application designs in order to be applied to a vehicle during the vehicle assembly. In particular, the sealers should not interfere with the assembly process (e.g., welding steps) and with any cleaning and coating processes that provide corrosion protection to the vehicle. These designs can be rather sophisticated and costly depending on the part of the vehicle and the cavity to be sealed. Past and current designs had to compensate via design in order to help ensure that the introduction of a sealer does not hinder or interfere with the cleaning and coating process of the vehicle during assembly. This includes drainage of cleaner(s) and coating(s) during a “body-in-white” assembly process, which utilizes immersion dip baths. When the vehicle exits these baths, unused fluids are drained out the vehicle.

Continuous filament non-woven web materials and mattings comprising such materials have been used in other field of technology, for example in the fields of mattings for use as floor covers. For example, U.S. Pat. No. 5,811,186 discloses a multi-component filament wherein the individual fibers have a sheath-core structure with an inner high melting polymer as the core which is covered with a second thermoplastic polymer with a lower melting point. This construction allows the individual filament fibers to be bonded to each other by heating to a temperature above the melting temperature of the outer polymer, but below that of the core polymer. Thus, the surface of a fiber sufficiently softens to fuse with another fiber at contact points of the fibers, while the non-melted core of the fiber helps ensure that the fiber maintains its shape.

U.S. Pat. No. 5,972,463 discloses mattings of the type used as floor coverings or doormats based on a filaments having a central core of an ethylene-propylene butene copolymer and a sheath of a second thermoplastic ethylene vinyl acetate copolymer blended with ethylene-methyl acrylate polymer wherein the individual filaments in the matting have a linear density of greater than 200 denier per filament and are durably melt-bonded at their points of intersection and contact.

U.S. Pat. No. 6,080,482 discloses multi-component filaments of a sheath-core structure having a linear density of 500 to 20000 denier per filament wherein the central core of the filaments is fabricated from polypropylene and ethylene-propylene-butene copolymers while the outer sheath copolymer is an ethylene-vinyl acetate copolymer blended with ethylene-methyl acrylate copolymer.

Continuous filament non-woven webs have also been used in medical applications as disclosed, for example, in US Patent Publication No. 2001/0000352A1. In these applications, the web possesses, without the necessity for adhesive binders, adjuncts, or post-extrusion melt processing, a cohesive shear strength exceeding 0.8 MPa when tension is loaded as a lap-shear sandwich joint. In this application, the webs are fabricated from biocompatible materials such as poly(glycolide)/poly(tri-methylenecarbonate)triblock copolymers, as within medical applications the webs are bio-degradable at least to some extent.

Continuous filament non-woven webs are disclosed in U.S. Pat. No. 5,055,151 and have been commercialized for use in covering steel or plastic pipes against damage by rocks as Tuff-N-Nuff® (Greenstreak group Inc.). Tuff-N-Nuff is advertised as a protective wrapping for underground piping and during the back-filling process and in these applications has to be flexible, while at the same time the material have voids for post installation quality testing such as cathodic probe testing. The Tuff-N-Nuff material is made of flexible PVC and has been suggested for use as antislip mattings, anti-microbial protection matting and, due to non-conducting nature of PVC, cathodic protection.

### SUMMARY

In accordance with an exemplary embodiment, a continuous filament non-woven web is disclosed, comprising: filaments of the web, which include an expandable thermoplastic material.

In accordance with another aspect, a process is disclosed for fabricating a continuous filament non-woven web, which includes melt spinning or extruding an expandable thermoplastic material at a temperature below an activation temperature of a propellant within the thermoplastic material.

In accordance with a further aspect, a process for sealing a cavity is disclosed, which includes inserting a continuous filament non-woven web in the cavity in combination with a matting, wherein filaments of the web include an expandable thermoplastic material; and activating a propellant in the thermoplastic material of the non-woven web or the matting by heat or electromagnetic irradiation for a time sufficient to expand the thermoplastic material.

In accordance with another aspect, a process is disclosed for sealing a cavity, which includes inserting a continuous filament non-woven web having an expandable thermoplastic material, in combination with a matting, in the cavity; and activating a propellant in the thermoplastic material of the non-woven web or matting by heat or electromagnetic irradiation for a time sufficient to expand the thermoplastic material.

In accordance with a further aspect, a method is disclosed for sealing a cavity, which includes applying a continuous filament non-woven web having an expandable thermoplastic material into the cavity.

### BRIEF DESCRIPTION OF THE DRAWING

Exemplary embodiments will be described in detail with respect to the drawings, wherein:

FIG. 1A depicts an exemplary sheet of filament non-woven web, which is positioned in a hollow profile orthogonal to the hollow space;

FIG. 1B depicts an exemplary thermoplastic material in which, after expansion of the expandable thermoplastic material, the material fills the profile as shown from one side;

FIG. 1C depicts an exemplary thermoplastic material in which, after expansion of the expandable thermoplastic material, the material fills the profile as seen from the opposite side;

FIG. 1D depicts another aspect in which an exemplary thermoplastic material is positioned in a hollow profile diagonally to the hollow space;

FIG. 1E depicts a hollow profile from one side after expansion of an exemplary expandable thermoplastic material; and

FIG. 1F depicts another hollow profile from an opposite side after expansion of an exemplary expandable thermoplastic material.

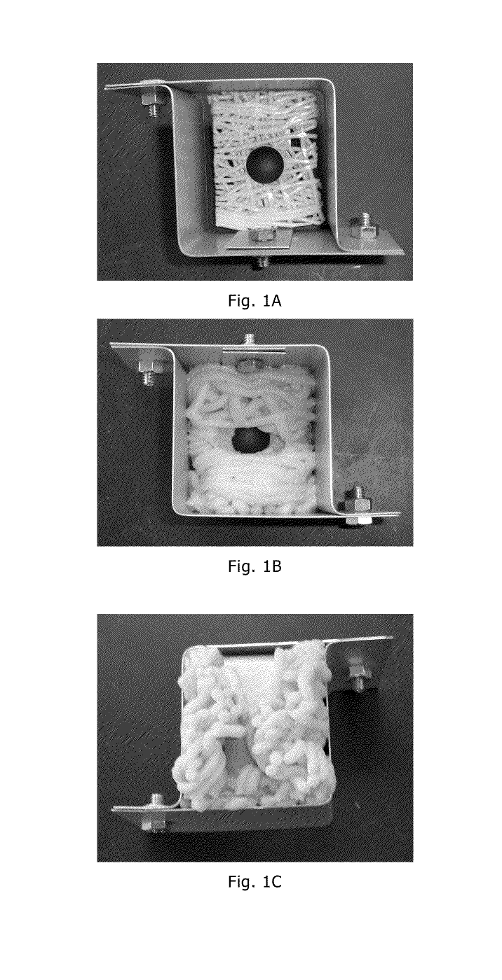

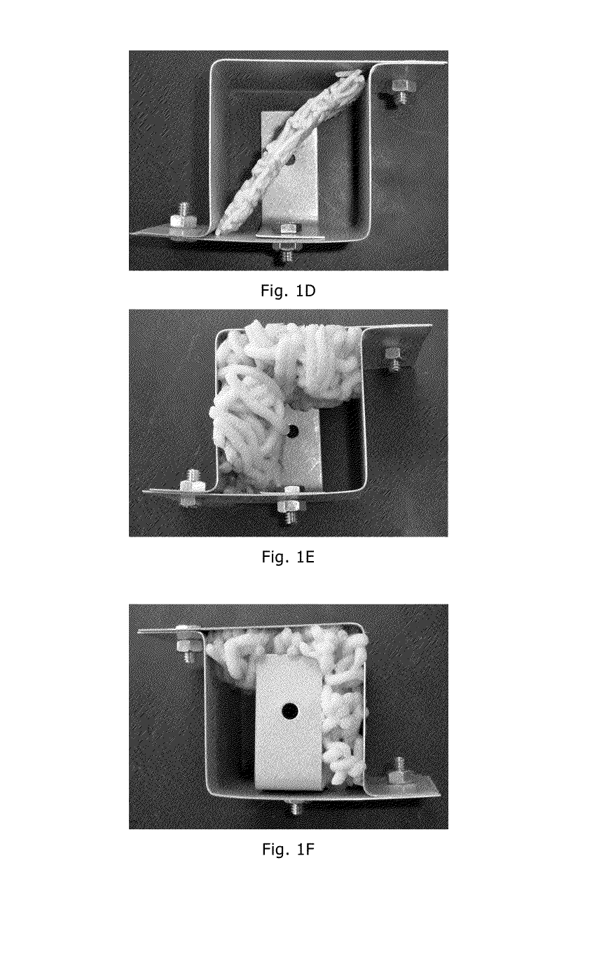

### DETAILED DESCRIPTION

In accordance with the present disclosure, exemplary continuous filament non-woven webs are disclosed wherein the filaments of the webs comprise an expandable thermoplastic material. A further aspect of the disclosure is directed at a matting, which includes a continuous filament non-woven web as identified above. For example, embodiments disclosed therein can be used as sealing materials for cavities into which liquids, such as cleaners and coatings, can be introduced and drained off prior to sealing the cavity with the web or matting.

Further aspects of the disclosure are directed to an exemplary process for fabricating said non-woven webs by extruding a thermally expandable thermoplastic material at a temperature below the activation temperature of a propellant comprised therein and a process for sealing a cavity comprising inserting the above-mentioned filament or matting into said cavity and activating a propellant in the thermoplastic material of the non-woven web by heat or electromagnetic irradiation to expand the material.

In sealing technology, and especially in the automotive field, there remains a need for a sealing material which can be inserted into a cavity to be sealed in the final product at a relatively early stage of the assembly process and can be activated to seal the cavity at a relatively late stage. For this purpose, the sealing material has initial dimensions which do not fill the entire cavity to allow for the application of cleaner(s) and coating(s) during the “body-in-white” assembly process and for rapid draining out of these liquids after application to a part. Moreover, the material should be available in a form suitable for processing in order to form the final part configuration (e.g., extrusion). The product lines for sealing applications are heat-expandable thermoplastic materials that are either injection-moulded or profile-extruded into, often times, three-dimensional parts. However, with such parts it may not be possible to apply and drain liquids used, for example, for cleaning and coating inside the cavities when, for example, a body of a vehicle moves through the assembly process. Due to this, draining points are designed into the injection-moulded part. It would therefore be desirable to have a material which does not include a complex pre-configuration such as fitting the same with draining points as specific positions.

One aspect of the present disclosure is to address the desire for fluid drainage during customer's final assembly process.

Another aspect of the present disclosure is to reduce or eliminate complex designs and therefore expensive tooling used for injection moulding or profile-extruding parts as well as to allow part communization. For example, to use one part or material for different sealing applications, which results in a simplification of manufacturing and a reduction of the part number.

Another aspect of the present disclosure is to reduce the materials used for sealing vehicle cavities, such as for example, nylon carriers produced through 2-component molding or overmolding.

In accordance with an aspect of the present disclosure, a continuous filament non-woven web, wherein the filaments of the web include an expandable thermoplastic material is disclosed. An exemplary continuous filament non-woven web according to the present disclosure can be inserted into a cavity and at that stage allows fluids to move through the cavity with little or no resistance. At a later stage the expandable thermoplastic material can then be activated, for example by heat during a primer and paint curing process, to seal the applied areas against air, water, or noise intrusion, the latter being of importance for passenger compartments in vehicles.

Exemplary features of the present disclosure can allow a significant simplification of pre-from designs in that the sealants are introduced in form of a continuous filament in non-woven web of a heat- or irradiation-reactive material which has a certain amount of entanglement and produces a sheet-stock of a thickness optimal for insertion into the respective cavities. Shaping methods such as thermo-forming, die-cut, water jet cutting and laser cutting can be used to bring the respective sheet-stock into a suitable form to help ensure 100% sealing of the intended cavity area. The expansion of the sealant can be effected during for example a paint or primer heat curing process of a vehicle during manufacturing.

Exemplary continuous filament in non-woven webs according to the present disclosure can be prepared by a process which comprises melt spinning or extruding a thermally expandable thermoplastic material at a temperature below the activation temperature of a propellant comprised therein. As a starting material, for example pellets of a thermally expandable thermoplastic material can be used. These pellets can then be processed further into a “random loop” configuration to ultimately produce a web of a filament non-woven. The thickness of this web can be varied based on the conveyor speed.

The filaments of the continuous filament non-woven web consist essentially of the expandable thermoplastic material. The web can include (e.g., consist essentially of) the mentioned filaments.

An exemplary base material of the expandable thermoplastic material is a thermoplastic polymer. This base-polymer can, for example, be an organic polymer having a melting point in the range of 20° C. to 400° C. The base polymer sufficiently softens at a temperature which is below the activation temperature of a propellant in the material so that deformation of the polymer is possible during a foaming process. When the activation temperature is reached, the base polymer is foamed. For example, a base-polymer has a melting point in the range of 60° C. to 200° C.

Suitable base-polymers, which are known to the skilled practitioner can be used. For example, a base-polymer in the context of the present disclosure can be selected from the group comprising (e.g., consisting of) ethylene vinyl acetate, polyolefine, polyvinyl chloride, XPS (crosslinked polystyrene) and polyamide (nylon). The base-polymers can be selected from polyvinyl chloride and polyamide. Exemplary preferred polyolefin are polymers based on ethylene or propylene. For example, a suitable ethylene polymer is low density polyethylene. In the practice of the present disclosure, the use of an ethylene vinyl acetate copolymer can be particularly preferred. Mixtures of the mentioned polymers can also be used, depending on the properties for the sealant in the desired application.

The base-polymer in most cases is the main component of the expandable thermoplastic material wherein the amount of base-polymer with regard to the sum of all components of the expandable thermoplastic material is, for example, preferably more than 50% by weight. It is, for example, particularly preferred if the content of the base-polymer is in the range of 65% to 95% by weight, in particular in the range of 70% to 90% by weight, and, for example, most preferably in the range of 75% to 85% by weight.

The expandable thermoplastic material can be activated and expanded, resulting effectively in the formation of a foam, by heating or by subjection to electromagnetic irradiation. For this purpose, the expandable thermoplastic material can, for example, contain a chemical or physical propellant. Chemical propellants are organic or inorganic compounds, which degrade under the influence of temperature, moisture or electromatic irradiation and wherein at least one of the degradation products is a gas. Physical propellants for example are compounds, which at higher temperatures form a gas. Thus, both chemical and physical propellants can trigger the formation of a foamed structure within the polymer blend.

In the practice of the present disclosure, the expandable thermoplastic material can be activated by the subjection to heat, for example, by heating the material to a temperature of less than or equal to 250° C. More preferably, the material can, for example, be activated at a temperature in the range of 100° C. to 230° C. and in particular in the range of 140° C. to 200° C. For example, chemical propellants are used for the expansion. The chemical propellants can include azodicarbonamides, sulphohydrazides, hydrogen carbonates or carbonates. For example, the azodicarbonamide is azobisformamide. Sulphohydrazides for example, can include p-toluene sulphonhydrazide, benzolsulphohydrazide and p,p′-oxybisbenzol sulphonyl hydrazide. For example, the bicarbonate is sodiumbicarbonate. Propellants can include azobisformamide and the p,p′-oxobisbenzene sulphohydrazide. Propellants are also commercially available under the trade names Expancell® from Akzo Nobel, Netherlands, the trade name Celogen® of Chemtura Corp., USA, or under the trade name Unicell® from Tramaco, Germany.

The heat for activation and foaming can be delivered by external or internal heat sources such as for example an exothermic chemical reaction.

With regard to the content of the propellant in the expandable thermoplastic material, the present disclosure is not limited. For example, the propellant in the expandable thermoplastic material can be in an amount ranging from 2% of 20% by weight, in particular in the exemplary range of 10% to 18% by weight, and most preferred in the range of 12% to 16% by weight, based on the total weight of the expandable thermoplastic material. In cases wherein a lower expansion of the material is desired, the content can also be lower, for example in the range of 2% to 10% by weight.

In a further aspect of the present disclosure, the expandable thermoplastic material is stabilized and consolidated during foam formation. For example, this can be achieved by the addition of crosslinkers, which are activated by degradation products of the propellant which initiate crosslinking of the resulting foam. The crosslinking of the expandable thermoplastic material takes place at a temperature which is equal to or above the activation temperature as otherwise crosslinking of the expandable thermoplastic material occurs before the foaming and it can help ensure that the expandable thermoplastic material fills the entire cavity before the foam hardens and assumes a compact structure.

With regard to the crosslinking of the obtained expanded thermoplastic material, the present disclosure is not particularly limited. Crosslinking of the foam is, for example, possible with crosslinking agents which do not react with the base polymer such as for example, epoxy-based crosslinking agents, or with crosslinkers which react with the base polymer. An example for such crosslinking agents are peroxide crosslinkers. For example, the crosslinking with peroxide crosslinkers or crosslinking with epoxides is preferred.

When crosslinking with peroxides is employed, known organic peroxides such as for example dibenzoyl peroxide, dicumyl peroxide, 2,5-di-(t-butylperoxyl)-2,5-dimethylhexane, t-butycumylperoxide, α,α′-bis(t-butylperoxy) diisopropylbenzene isomeric mixture, di-(t-amyl)peroxide, di-(t-butyl)peroxide, 2,5-di-(t-butylperoxy)-2,5-dimethyl-3-hexine, 1,1-di(t-butylperoxy)-3,3,5-trimethylcyclo-hexane, n-butyl 4,4-di-(t-butylperoxy)valerate, ethyl 3,3-di-(t-amylperoxy)-butanoate, or t-butyperoxy-3,5,5-trimethylhexanoate can be used. For example, the peroxide is dicumylperoxide.

If epoxy-based crosslinkers are used, an exemplary mixture of an epoxy containing polymer and a maleic anhydride containing polymer has proven as particular advantageous. The epoxy containing polymer for example is a copolymer of ethylene and glycidylmethacrylate having a content of glycidyl monomer in the range of 4% to 12% by weight based on the weight of the copolymer. For example, the maleic anhydride group containing polymer is a terpolymer of ethylene, an alkyl acrylate or methacrylate, for example, on the basis of an alkyl alcohol with 2 to 10 carbon atoms, and maleic anhydride. The content of a maleic anhydride in the terpolymer is for example in the range of 1.5% to 5% based on the total weight of the terpolymer. For example, the two crosslinking components are present in a ratio from 2:1 to 1:2, and in particular about 1:1.

The above polymer combination is suitable in combination with propellants, which upon heating release water or alcohol, as the evolving water or alcohol hydrolyzes the maleic anhydride to maleic acid which then allows for a reaction of with the epoxy groups of the epoxy containing polymers resulting in crosslinking.

For example, in the thermally expandable thermoplastic material, the crosslinking agent is present in a content ranging from 1% to 25% by weight, based on the total weight of the expandable thermoplastic material, for example, in the range of 2% to 18% by weight, and most preferably in the exemplary range of 2% to 10% by weight. In case a peroxide is used as a crosslinking agent, the concentration can be lower, for example, in the range of 1% to 5% by weight, and more preferably in the exemplary range of 1% to 2% by weight.

In a further aspect, the thermally expandable thermoplastic material does not contain a crosslinker.

For example, the exemplary thermally expandable thermoplastic material should contain sufficient propellant to allow for an expansion of at least about 20%, for example, at least about 100%, and more preferably at least about 500%, even more preferably at least about 1000% and most preferably at least about 1500% of its non-expanded volume. The maximum expansion should, for example, not exceed 20000%, preferably 5000% and most preferably 2500% of its non-expanded volume.

For example, exemplary dimensions of the individual filaments in the non-woven web are such that the filaments have a thickness in the range of from 0.5 mm to 3 mm, in particular 0.75 mm to 2 mm and most preferably 1 mm to 1.5 mm.

A further aspect of the present disclosure is a matting having a continuous filament non-woven web as disclosed above. Such matting is easy to handle in an assembly of automotive parts, and for example, can either be die-cut into the desired dimensions or slit into strips, depending on the engineering specifications. The resulting die-cut parts or strips can then be processed even further to include assembly aids such as nylon attachments or adhesives for the attachments to the body-in-white steel frame.

An exemplary matting has a thickness in the range of 0.01 mm to 10 mm, more preferably in the range of 0.60 mm to 6 mm, and in particular in the range of 1.5 mm to 4.5 mm. For example, the matting has a surface weight in the range of from 0.1 kg/m²to 5 kg/m², more preferred in the range of from 0.3 kg/m²to 3 kg/m², and in particular in the range of from 0.6 kg/m²to 1.5 kg/m².

The matting may include (e.g., consist essentially of) the expandable thermoplastic material, or may comprise a base material onto which the expandable thermoplastic material is applied. For example, such base material can include (e.g., consist of) the wire mesh. For example, a wire mesh based on nylon. The resulting matting has a high surface area for heating and can be used in the automotive or construction fields.

A yet further aspect of the present disclosure is a hollow article having a cavity, into which a non-woven web or matting as disclosed above has been inserted and expanded to fill at least part of the cavity. In one exemplary aspect, the non-woven web or matting has been expanded to substantially fill the entire cavity. In another aspect, the exemplary non-woven web or matting has been expanded such that only part of the hollow article is filled, but air or liquid cannot pass from one side of the article to the other through the expanded material.

A further aspect is a process for fabricating a continuous filament non-woven web as disclosed above comprising melt spinning or extruding an expandable thermoplastic material at a temperature below the activation temperature of a propellant therein into the shape of a continuous filament non-woven web. For example, in the practice of the present disclosure, extruding is preferred in the above-mentioned process. Suitable devices and parameters for this process are known, and for example, are disclosed in U.S. Pat. No. 5,055,151 or US Patent Publication No. 2011/0293764A1, the contents of which are incorporated herein by reference in their entireties.

A further aspect is a process for sealing a cavity, which includes inserting a continuous filament non-woven web or a matting as disclosed above into a cavity, and activating a propellant in the thermoplastic material of the non-woven web or matting by heat or electromagnetic irradiation for a time sufficient to expand the thermoplastic material.

In accordance with an aspect, the continuous filament non-woven web can be cut into the desired shape for the cavity to be filled by die cutting or slitting into appropriate strips depending on the shape of the cavity. Alternatively, the web could be brought into the desired shape by bending or thermoforming at a temperature below the activation temperature of the propellant. For example, the material could be rolled into a tube or bent with multiple angles.

A further aspect of the present disclosure is directed to the use of a continuous filament non-woven web or a matting as disclosed above for sealing applications. For example, for automotive applications including for example, sealing vehicle cavities. Another aspect is directed at the use of a continuous filament non-woven web or a matting as disclosed above for concrete expansion joint sealing.

Yet another aspect of the present application is directed at the use of a continuous filament non-woven web or a matting as disclosed above in non-drain applications such as a gap between concrete plates, or for pothole repair. In these applications, the propellant can be activated by indirect heat such as by heat of rolled asphalt being applied together with or onto the filament non-woven web or matting.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A continuous filament non-woven web, comprising:
filaments of the web, which include an expandable thermoplastic material.

2. The non-woven web according to claim 1, wherein the filaments consist essentially of the expandable thermoplastic material.

3. The non-woven web according to claim 1, wherein the filaments are arranged in a random loop configuration.

4. The non-woven web according to claim 1, wherein the thermally expandable thermoplastic material has a maximum expansion of at least about 100% of its non-expanded volume.

5. The non-woven web according to claim 1, wherein the thermoplastic material comprises:
ethylene-vinylacetate, polyolefine, polyvinylchloride, crosslinked polystyrene, polyamide, or a combination thereof.

6. The non-woven web according to claim 1, wherein the filaments have a thickness in range of about 0.5 mm to 3 mm.

7. The non-woven web according to claim 1, comprises:
a chemical propellant which is selected from the group consisting of azodicarbamides, sulphohydrazides, hydrogen carbonates and carbonates.

8. The non-woven web according to claim 1, wherein the thermoplastic material includes a crosslinking agent.

9. The non-woven web according to claim 1, in combination with a matting.

10. The non-woven web according to claim 9, wherein the matting has a thickness of about 0.01 mm to 10 mm.

11. The non-woven web according to claim 9, wherein the matting has a surface weight of about 0.1 kg/m²to 5 kg/m².

12. The non-woven web according to claim 1, in combination with a hollow article having a cavity, into which the non-woven web has been inserted and expanded to fill at least part of the cavity.

13. The non-woven web according to claim 9, in combination with a hollow article having a cavity, into which the matting has been inserted and expanded to fill at least part of the cavity.

14. A process for fabricating a continuous filament non-woven web, comprising:
melt spinning or extruding an expandable thermoplastic material at a temperature below an activation temperature of a propellant within the thermoplastic material.

15. A process for sealing a cavity comprising:
inserting a continuous filament non-woven web in the cavity in combination with a matting, wherein filaments of the web include an expandable thermoplastic material; and
activating a propellant in the thermoplastic material of the non-woven web or the matting by heat or electromagnetic irradiation for a time sufficient to expand the thermoplastic material.

16. A process for sealing a cavity comprising:
inserting a continuous filament non-woven web having an expandable thermoplastic material, in combination with a matting, in the cavity; and
activating a propellant in the thermoplastic material of the non-woven web or matting by heat or electromagnetic irradiation for a time sufficient to expand the thermoplastic material.

17. A method for sealing a cavity, comprising:
applying a continuous filament non-woven web having an expandable thermoplastic material into the cavity.

18. The method according to claim 17, wherein the cavity is a vehicle cavity.

19. The method according to claim 18, comprising:
a matting in combination with the continuous filament non-woven web.

20. The method according to claim 17, wherein the cavity is concrete expansion joints.

21. The method according to claim 20, comprising:
a matting in combination with the continuous filament non-woven web.
